(19) United States
(12) Patent Application Publication
(10) Pub. No.: US 2003/0064355 A1
(43) Pub. Date: Apr. 3, 2003

(54) Multi-media teaching method

(76) Inventor: Susan L. Florance, Stilwell, KS (US)

Correspondence Address: James J. Kernell, Chase & Yakimo, L.C., Suite 130, 4400 College Boulevard, Overland Park, KS, 66211, US

(21) Appl. No.: 09/966,182

(22) Filed: Sep. 28, 2001

(51) Int. Cl. G09B 7/00

(52) U.S. Cl. 434/362

(57) ABSTRACT

A method of organizing and presenting information related to a student's academic career is provided which includes creating a series of folders and subfolders for organizing multimedia information chronologically and hierarchically for each student. The information may be presented in a variety of ways such as by academic subject matter spanning one or more years or by grade level.

### BACKGROUND OF THE INVENTION

This invention relates to a method of teaching using multi-media presentations and, in particular, to a method of teaching that enhances coherence of a curriculum within an academic school year and from academic year to academic year by providing a framework used to demonstrate a student's cumulative academic understanding with technology integration in a multi-media format.

The traditional primary educational system is organized by grade level and curriculum within each grade level. The curriculum for each grade level is divided into subjects such as reading, science, math and social studies. Traditionally, each subject is treated in isolation and separate from the other subjects. A student's understanding of a subject is measured by the student's performance on homework assignments, projects and by test scores. At the end of the school year each student is assigned a final grade based on the student's overall performance in each subject area. From year to year new subjects may be added to the curriculum or advanced topics are taught in a continuing subject matter. A problem with this educational model is that the curriculum is often disjointed within a school year as well as from year to year. This model provides no continuity for a student going from class to class or from grade to grade. Additionally, a student's development and advancement is lost when reduced to a single letter grade.

### SUMMARY OF THE INVENTION

It is therefore the primary object of the present invention to provide a method of integrating the subjects of a curriculum within an academic school year.

Another important object of the present invention, as aforesaid, is to provide a method of integrating the curriculum from year to year.

Yet another important object of the present invention is to provide a method, as aforesaid, which produces a cumulative, sensory integrated, multi-media computer generated student portfolio.

Still another important object of the present invention is to provide a method, as aforesaid, which may be used to assess and evaluate a student's understanding of a subject.

Still another important object of the present invention is to provide a method, as aforesaid, which may be used to demonstrate a student's cumulative academic understanding of a subject.

### BRIEF DESCRIPTION OF THE DRAWINGS

FIG. 1 is a block diagram illustrating integration of the curriculum subject matter from grade to grade for a student powerfolio presentation.

FIG. 2 is a diagrammatic illustration of a computer network and associated components.

FIGS. 3 and 4 are flowcharts illustrating the method of integrating the subjects of a curriculum and the curriculum from year to year for a single student within a powerfolio folder.

### DESCRIPTION OF THE PREFERRED EMBODIMENTS

A PowerPoint® portfolio (powerfolio) presentation organizes information by folders, sub-folders, and slides with the folders and sub-folders. Related information may be organized within a folder sequentially behind a title slide or slide introducing the subject matter, or sequentially within a folder for that subject. This information, in the form of a set of PowerPoint® slides, may be organized hierarchically by student, curriculum for an academic year, and by subject, or may be organized by student and subject across all academic years. Additional hierarchical levels and organizational methods may be added to further organize the slides as appropriate. For example, within a math subject, the slides may be organized by lesson and summarized on a slide by a student's achievement toward meeting the expected outcome for that lesson. Each year another set of folders and subfolders and slides are added from the curriculum level down to a student's powerfolio folder or CD. In this manner, an integrated record is kept of the student's academic career, which may be sequentially displayed in a multi-media presentation or slide show presentation.

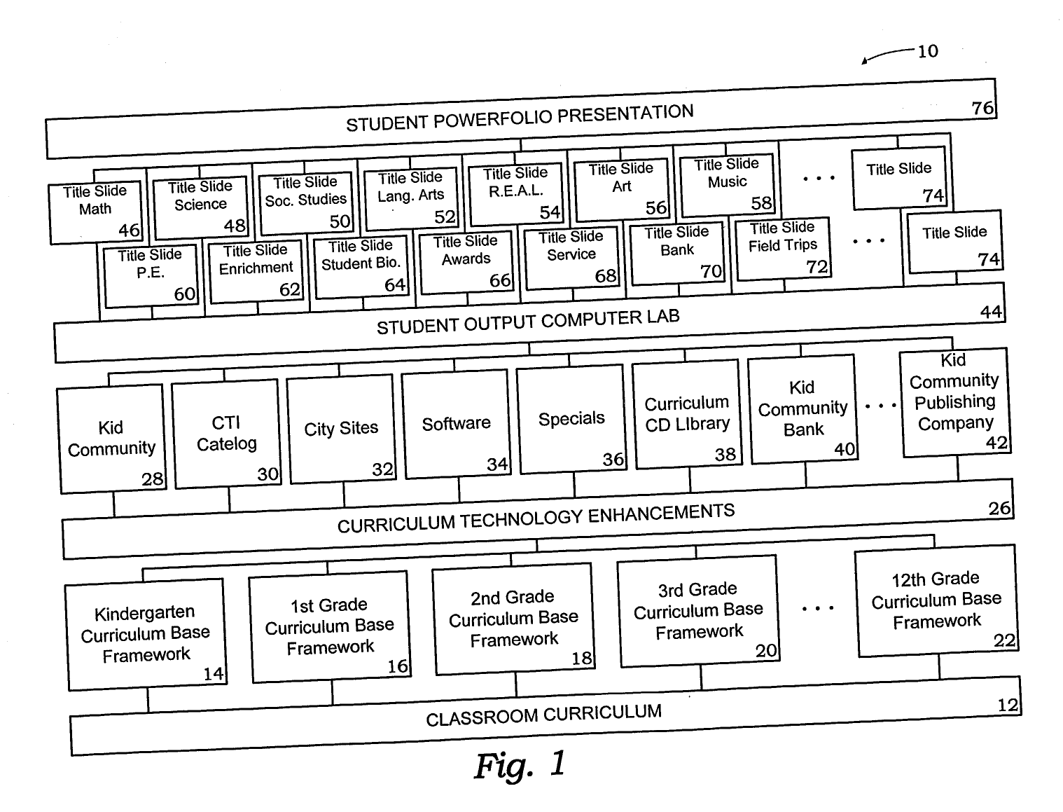

FIG. 1 illustrates the sources of information that may be used in the creation and organization of a student's powerfolio presentation 10. The classroom curriculum 12 is based on the academic requirements of a given school district which may include general guidelines, goals and standards to apply to all grade levels and schools throughout the district, specific subjects and outcomes for a grade level or group of grade levels. The classroom curriculum 12 is translated into a specific curriculum base framework such as the kindergarten curriculum base framework which is derived from classroom curriculum 12. A curriculum base framework is derived for each of the primary grades kindergarten 14, first grade 16, second grade 18, third grade 20, and so on through 12th grade 22. The curriculum base framework is not limited to K-12 grade levels and may include pre-K, college, special education, graduate and post graduate, vocational and other training. Each curriculum base framework 14-22 is organized by curriculum subject and lessons within that subject. Each of the subjects includes objectives and expected outcomes.

For example, the kindergarten curriculum framework may include subjects such as reading, math, spelling, writing, and art. For each of these subjects is an associated set of outcomes which serve to measure a student's mastery of the subject and academic achievement.

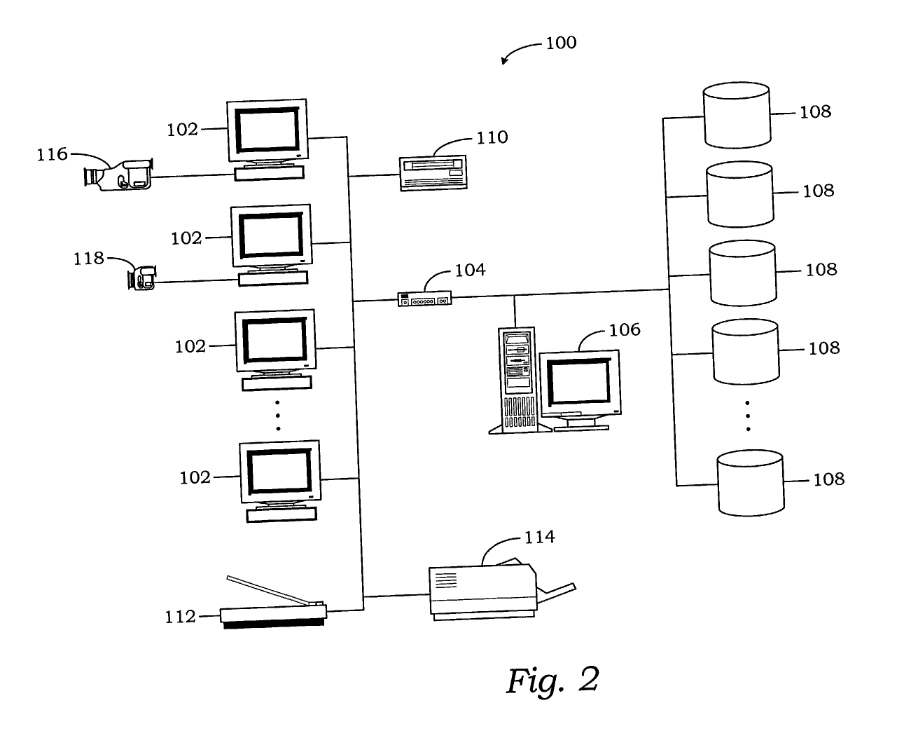

Each curriculum base framework is converted into electronic files through the use of PowerPoint running on a personal computer 102 within a computer network 100 (FIG. 2) which is generally referred to as curriculum technology enhancements 26. A student or teacher may use classroom computers 102 or computers in a computer lab networked together through a router or hub 104 which is connected to the network server 106. A network version of PowerPoint may be installed on the server 106 to enable any student or teacher at one of the computers 102 attached to network 100 to use the software. A series of hard drives 108 are connected to server 106 to provide electronic storage for the students' powerfolio presentations and other information.

A rewriteable compact disk drive 110 is connected to the network 100 so that a student's powerfolio may be transferred from the hard drives 108 to a CD to free up space on the hard drives 108, and to provide long term stable storage of the presentation. Other hardware components that may be interfaced with network 100 are a scanner 112, printer 114, video camera 116, and digital camera 118.

The students and teachers use the computers 102 to create slides that are saved on the network hard drives 108 within each student's powerfolio folder. The students use information available on the network through the computer lab (represented by blocks 28-42 of FIG. 1 which will be discussed in detail below), and the students' own classroom output 44 for objects on the individual slides of their presentations.

The slides are organized by subject behind a title slide. Some subject title slides that may be used are as follows: Math 46, Science 48, Social Studies 50, Language Arts 52, Reading Enrichment 54, Art 56, Music 58, Physical Education 60 and Enrichment At 62. Additionally, a student may wish to include slides such as Student Biography 64, Awards and Certificates 66, Service Contributions 68 which may include community service hours, use of the Student Bank 70, and Field Trips 72. Other slides 74 may be added as necessary.

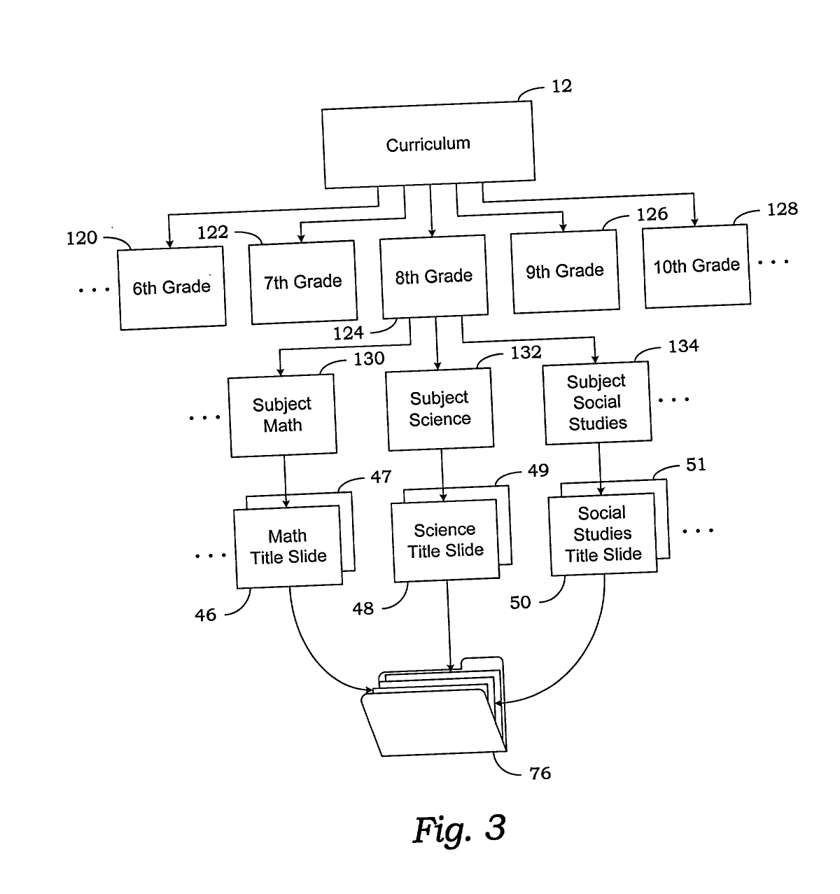

Referring to FIGS. 2 and 3, powerfolio is driven by the classroom teacher's periodic completion of a curriculum summary worksheet, either manually or electronically using a computer 102. A curriculum summary worksheet is an outline of a subject within a curriculum including objectives and expected outcomes for the following academic calendar period. This information is used either directly or indirectly to create the subject matter of each powerfolio slide for each student. A teacher may enter the objectives and expected outcomes directly into a title slide for a particular subject which is then loaded onto the network 100 and stored in the electronic file for that grade level and subject. Alternatively, a teacher may fill out a paper worksheet that is subsequently entered into the appropriate slide by a computer lab technician or administrator. Based on the curriculum summary worksheets, a powerfolio framework is created for each student and saved on the network in the student's personal folder (see FIG. 1, blocks 46-72).

Each student maintains a slide summary outline checklist, which allows a student to keep track of his or her progress on the student's powerfolio. The checklist allows the students to progress at their own speed and track their progress, which increases the student's sense of independence and achievement. New slides are inserted behind the appropriate curriculum subject title slide where they accumulate until being transferred onto a CD.

Referring to FIG. 3, the curriculum 12 is divided by grade level. Although the sixth through tenth grades (blocks 120-128) are shown in FIG. 3, it should be understood that the curriculum 12 may be divided into any number of grades from kindergarten through 12th grade. Next the curriculum 12 for each grade level is divided by subject. Math 130, science 132, and social studies 134 subjects are shown in FIG. 3. Again any number of subjects may be included in a curriculum for a given grade level. Based on the subject, title slides 46, 48, and 50 are created for each of the respective subjects and stored in an electronic folder 76 for each student in the corresponding grade. A set of one or more blank slides, 47, 49 and 51, which include instructions for the student, may be included with the title slides to provide the students with a checklist of outcomes expected for the particular subject and the method or instructions to aid in achieving those outcomes. At this point, each student's folder 76 contains the framework for each student's powerfolio for the current academic year. However, the folder 76 does not contain any individual works created by the student.

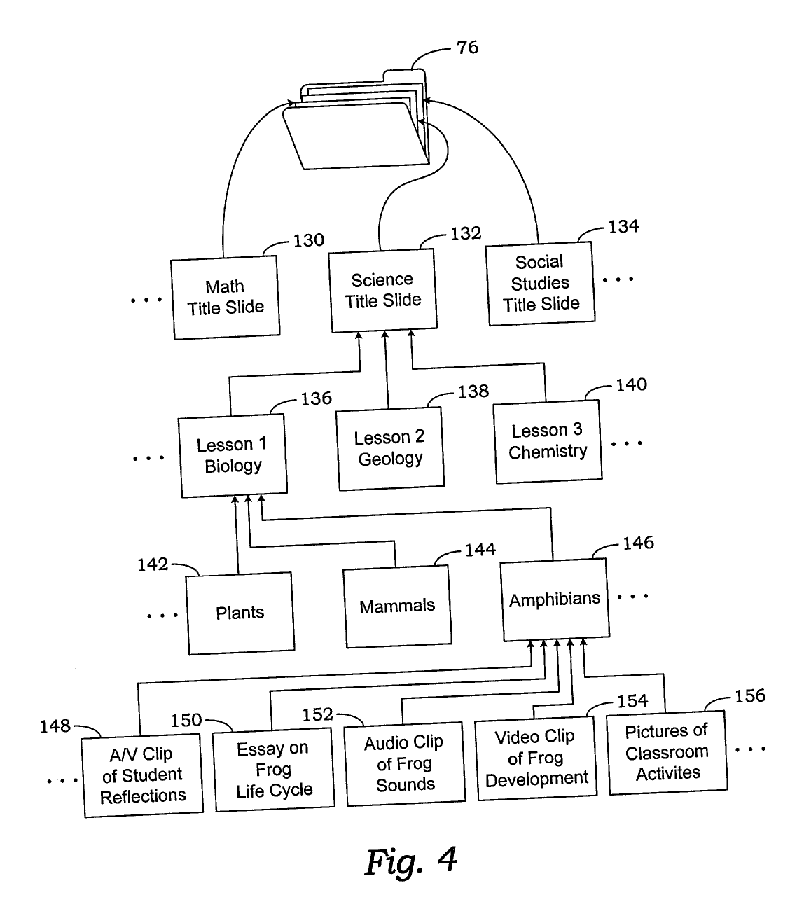

Referring to FIG. 4, as the academic year progresses, an eighth grade science teacher will provide lessons in biology 136, geology 138 and chemistry 140, for example. The biology lesson 136 may include segments on plants 142, mammals 144 and amphibians 146, to name a few. As the students study amphibians each student may be required to write a research report about a frog's life cycle which is then linked to a slide 150, for example. Live tadpoles may be used to observe and study a frog's development. The frog's development may be captured using a video camera 116 or a digital camera 118 (FIG. 2) and stored as a video clip 154, an audio clip 152 or a series of digital pictures 156. A slide for each of the significant activities 156 may be developed to record a student's progress toward a desired outcome. The slides may be organized by placing them behind the amphibian slide 146. The amphibian slide 146 and slides 148-156 are placed behind the biology slide 136, which is in turn placed behind the science slide or within the science folder 132 in a student's folder 76. The title slide for each subject may include a table of contents to indicate the specific area of study and provide easy access to the individual lessons and areas studied.

In addition to information obtained through classroom activities, a student may also include other information related to a subject. Referring to FIG. 1, Kid Community 28 is an electronic folder available on the network 100 (FIG. 2), which includes curriculum folders, grade level classroom folders, staff and student portrait pictures, a kid community garage sale folder and PowerPoint(& curriculum presentations.

The curriculum folders consist of a folder for each curriculum subject being taught at each grade level including subject enhancements such as maps, pictures, written articles and Internet links to appropriate curriculum sites.

Grade level classroom folders are provided to store digital camera images of student and/or classroom projects which may be imported into student portfolios. Teachers can also use these folders for future assignments to be imported into students' powerfolio behind the appropriate subject title. Staff and student portrait pictures may be imported into classroom projects or student portfolios.

The Kid Community garage sale is a folder comprised of student merchandise for sale such as toys, Nintendo, CDs, books or sports equipment. Students can buy and sell items through the kid community garage sale. Sellers may donate a percentage of their profits to a local charity.

PowerPoint® curriculum presentations that have been created either by students or staff pertaining to a particular curriculum subject are stored in another folder within the Kid Community 28. These presentations may be used for study, research or to enhance teacher instruction.

Curriculum technology integration (CTI) catalog 30 is a catalog of appropriate Internet sites filed by grade level and curriculum subject which may be used for student reference of classroom instruction.

City sites 32 may consist of a virtual or electronic city of buildings and landmarks graphically displayed on a web page that reference Internet links and links to information on the local network pertaining to a particular curriculum subject. For example, a student may select the capitol building in the virtual city to get information about government, politics or links to other government sites. Virtual works of art may be displayed in the art museum along with links to famous museums around the world. Students may find out facts about nutrition and consumerism by selecting the grocery store. Information about the weather may be obtained by selecting the weather station to connect the student to the National Weather Forecasting Center and to view the latest satellite images. The virtual television station may connect the student with the school's television station anchors reporting the local school news and to other local television station web sites. A wilderness science center may provide access to PowerPoint& presentations concerning past wilderness lessons. A student service center may be used to request volunteers to read to a special needs student from 2:45 from 3:00 on Mondays, for example. A city science center may be linked to all science curriculum subjects similarly fitness center may be linked to the physical education curriculum. By selecting the symphony, a student may find information on various composers, or listen to Beethoven's Fifth Symphony. These are only a few examples of the wide variety of information that may be available in the virtual city.

Educational software 34 may be available to enhance quality performance accreditation (QPA) goals and curriculum and to broaden a student's understanding of a subject area. The specials folder 36 may include folders for music, art, P.E., computer instruction, reading enrichment or Spanish, for example.

Each of the teaching specialists contributes either digital camera images of student projects from their class, voice recordings and/or video recordings which may be imported into a student's powerfolio. For example, The music teacher may provide student voice recordings or video segments of musicals, plays, choirs, strings and band. The P.E. teacher may provide physical fitness scores for each student such as the time to run a mile, number of sit-ups or pull-ups performed by each student. These statistics may then be imported by a student into their P.E. performance graph on the P.E. slide.

Digital camera images using digital camera 118 (FIG. 2) of a student's artwork may be included in the art folder or stored on the student's floppy disk, which may subsequently be imported into a student's powerfolio. The reading enrichment teacher may record or video a student giving a book report which is then stored in the reading enrichment folder. Likewise, the Spanish teacher may record or video segments of a student speaking Spanish to be imported into their language arts slide.

Curriculum CD library 38 consists of a library of kid community curriculum folders which are periodically copied onto CDs to create the curriculum subject library. This information may be used to enhance learning in a particular subject area and for classroom presentations.

Kid community bank folder 40 consists of a “bank account” which keeps track of the deposit of all service points, virtue coupons and classroom points that a student may earn. Withdrawals are recorded for failure to hand in homework, or other discipline issues. The points may be used to purchase books, other items, or privileges.

Student publishing company folder 42 is a virtual publishing company operated by students in which work orders are placed in the student publishing company folder requesting printed items such as business cards, greeting cards, banners or award certificates. Students learn how to use publishing software such as Microsoft Publisher, form design, layout and word processing, and the operations of a simple business. Additionally, students may earn service points for their contribution to the publishing company. Student publishing company 42 may be a separate folder accessible through City Sites 32 as a publishing company, or may be included in City Sites 32.

### Powerfolio Example

Powerfolio may be driven by classroom teacher's completion of a curriculum summary worksheet. This worksheet may be completed prior to school starting so that each student's folder for that academic year may be created. The worksheet is an outline of the objectives and expected outcomes for each subject, which is part of the curriculum for the current academic year. This outline is used to direct the subject matter of each powerfolio slide.

Each student maintains a slide summary outline checklist, which allows a student to keep track of his or her progress on their powerfolio. The slide summary outline may be kept manually or electronically as a blank slide with instructions.

The lessons are filed by grade level and curriculum subject. The lessons are easily accessed by students for independent study. Each powerfolio lesson requires a student to reflect on a culminating unit of study. Their reflections are placed on a new slide within their powerfolio along with appropriate pictures, animation, sound effects, slide transitions and voice recordings where appropriate. Each student is given a disk to accumulate digital camera pictures of his classroom projects, wilderness activities, field trips, video excerpts of classroom reports and presentations, reading samples or photos of themselves involved in any school activity, reports and essays. This information is periodically transferred to the student's folder 76 stored on the network 100. Twice a year, a student's powerfolio presentation is transferred onto each student's individual CD to free up network memory. For the lower grades, the teacher may organize and store each student's works electronically until the children are able to operate a computer themselves.

Classroom teachers may also accumulate digital camera pictures of whole classroom activities and projects. This information is then transferred to the network where it is stored and organized by teacher and grade in a database or other electronic filing system. Students may then select pictures available for a particular slide from this library and import them into their powerfolio presentation.

Each academic specialist also contributes to a student's powerfolio by providing digital camera pictures of class projects, recordings or written samples. For example, the music teacher may provide digital camera video segments for each student showing a student's performance in a recital. Again, this information is stored in a database or other filing system on the network to be available for use by the student's in their powerfolio. The art teacher may have students take digital camera pictures of their art projects before they are taken home. A Spanish teacher may record student's recital of speaking samples pertaining to their Spanish curriculum for their powerfolios. In P.E., physical performance statistics for each student may be plotted on a physical fitness growth chart within a student's powerfolio presentation behind the P.E. title slide.

It is to be understood that while certain forms of this invention have been illustrated and described, it is not limited thereto except insofar as such limitations are included in the following claims and allowable equivalents thereof.

Having thus described the invention, what is claimed as new and desired to be secured by Letters Patent is as follows:

1. A method for organizing and presenting information related to a student's academic career comprising the steps of:
(a) creating an electronic student folder for electronic organization of information related to the student's academic career;
(b) creating an electronic academic year subfolder within each student folder for a first academic year;
(c) creating an electronic subject subfolder within said academic year subfolder corresponding to an academic subject of a curriculum for said first academic year;
(d) storing electronic files comprising information relating to said academic subject in said subject folder;
(e) creating links between said files and said subfolders for presentation in an organized manner; and
(f) presenting said information contained in said files according to said links.

2. The method as claimed in claim 1 wherein said step (e) comprises chronologically linking said files within said subject subfolder and hierarchically linking said subfolders within said student folders.

3. The method as claimed in claim 1 further comprising repeating steps (c)-(f) for each of a plurality of subjects of said curriculum for said first academic year.

4. The method as claimed in claim 3 further comprising repeating step (b) for each of a plurality of academic years for said student's academic career.

5. The method as claimed in claim 4 wherein step (e) comprises chronologically linking said files within each subject subfolders and chronologically linking each subject subfolder with a like subject subfolder within each academic year subfolder.

6. The method as claimed in claim 5 wherein step (f) includes presenting said information chronologically for said subject and said like subjects within said academic year subfolders.

7. The method as claimed in claim 1 wherein said files include electronic slides, images, videos, documents, or links to other files in other subfolders, or any combination thereof.

8. A method of organizing and presenting information related to a student's academic career comprising the steps of:
(a) creating an electronic grade level folder;
(b) creating an electronic subject subfolder within said grade level folder;
(c) creating an electronic lesson subfolder within said subject folder;
(d) creating an electronic file related to said lesson; and
(e) storing said electronic file within said lesson subfolder.

9. The method as claimed in claim 8 further comprising the step of creating an electronic links folder within said subject subfolder for storing electronic links to information related to said subject.

10. The method as claimed in claim 8 further comprising the step of creating an electronic multimedia subfolder within said subject subfolder for storing multimedia files related to said subject.

11. The method as claimed in claim 8 further comprising the step of creating an electronic presentations subfolder within said subject subfolder for storing presentation files related to said subject.

12. The method as claimed in claim 8 further comprising the step of creating links between said electronic file, subfolders and folder.

13. The method as claimed in claim 12 further comprising the step of presenting information contained in said file according to said links.

14. The method as claimed in claim 12 wherein said links are created chronologically for said lesson and subject.

15. The method as claimed in claim 12 wherein said links are created hierarchically between said subfolders and folder.

16. The method as claimed in claim 8 further comprising the steps of.
(f) creating an electronic student folder for organization of information related to the student's academic career, and
(g) copying said electronic grade level folder and subfolders into said student folder.

17. The method as claimed in claim 16 further comprising the step of:
(h) repeating steps (a)-(c) for each of a plurality of grade levels for said student's academic career.

18. The method as claimed in claim 17 further comprising the step of:
(i) repeating steps (f)-(h) for a plurality of students.

19. The method as claimed in claim 18 further comprising linking said subject subfolders between each of said plurality of grade levels for each of said plurality of students.

20. The method as claimed in claim 19 further comprising presenting information contained in said linked subject subfolders chronologically for a student.
